(19) United States
(12) Patent Application Publication
(10) Pub. No.: US 2025/0078048 A1
(43) Pub. Date: Mar. 6, 2025

(54) A SYSTEM ENABLING LOYALTY PROGRAMS TO BE USED MORE EFFECTIVELY

(71) Applicant: Goart Teknoloji Anonim Sirketi, Merkez Elazig (TR)

(72) Inventor: Esra Soylu

(21) Appl. No.: 18/282,951

(22) PCT Filed: Mar. 6, 2023
(86) PCT No.: PCT/TR2023/050214

§ 371 Date: Sep. 19, 2023

(30) Foreign Application Priority Data
Nov. 22, 2022 (TR) 2022017619

(51) Int. Cl. G06Q 20/06; G06Q 30/0226

(52) U.S. Cl. CPC G06Q 20/06; G06Q 30/0233

(57) ABSTRACT

The invention relates to a system which allows transactions of a user, such as collecting, sharing and selling NFTs (non-fungible tokens) and/or tokens to be executed and the loyalty programs to be used more effectively, wherein the system converts NFTs (non-fungible tokens) and/or tokens transferred to a three-dimensional world by an augmented reality technology into loyalty scoring systems and/or cryptocurrencies of sellers operating in different industries.

### TECHNICAL FIELD

The invention relates to a system which allows transactions of a user, such as collecting, sharing and selling NFTs (non-fungible tokens) and/or tokens to be executed and the loyalty programs to be used more effectively, wherein the system converts NFTs (non-fungible tokens) and/or tokens transferred to a three-dimensional world by an augmented or virtual reality technology into loyalty scoring systems and/or cryptocurrencies of sellers operating in different industries.

### PRIOR ART

Loyalty programs are a structured marketing strategy widely used in various industries to encourage a consumer to shop and use the products and services of sellers/manufacturers. Loyalty programs are structured to help build a stronger relationship between the trademark and a customer/consumer. In the present art, scoring systems used in loyalty programs are carried out in certain standards. Companies or sellers have difficulty in reaching target audiences for their advertising and awareness. Therefore, the cost and competition is increasing gradually. In addition, companies or sellers cannot reach an end user directly by using traditional methods, especially social media platforms.

Today, substantial increases are observed in the fields of augmented reality and virtual reality due to the development of the existing technology. These reality fields are used in many industries. The systems and applications are quite less in number for users to make money, especially in the fictional or real world. There are no systems both depending on a user's movement and taking into account the wishes of a user, in which the loyalty scoring systems used in the present art are combined together with the augmented reality and virtual reality technologies. In addition, blockchain technology and NFTs (non-fungible tokens) replaces traditional systems as another known and increasing technological developments. It is very difficult for users to transfer the money earned or points scored in some systems and applications to real-world payment systems, and to make a gain. There is a need for more reliable and faster applications and systems in the form of NFT or cryptocurrency using blockchain technology.

In the state of the art, there is no system or application which combines virtual reality and augmented reality environment with blockchain technology and allows users to visit and see locations and places they desire in the real or fictional world, or to discover the breezes of that period in ancient histories and places.

In the patent application no. US2021150560 in the state of the art, a method and system used by a user to manage loyalty points are disclosed. Said document does not disclose the collection of loyalty points and the conversion to NFT and cryptocurrency with blockchain technology in payment methods, and the transfer of said system to the real or fictional world for users, and therefore it is different from the system of the invention.

In the patent application no. US2021110423 in another state of the art, a system, method and a computer-readable medium are disclosed for the advanced management of a distributed ledger technology or a blockchain-based customer loyalty program. In said system, tokens or credits are provided according to the user's transactions.

However, it is different from the system of the invention, since making money over the system in the real or fictional world which is opened by the user's logging in from the portal is not disclosed.

### BRIEF DESCRIPTION OF THE INVENTION

The invention relates to a system providing users with experience in the real and/or fictional world. By the augmented or virtual reality technology, the system may be designed in accordance with the period in any past and future time, and thus offers an opportunity to explore a fictionalized environment. Especially in the fictional world, there are more valuable NFTs (non-fungible tokens), and they may further converted into to cryptocurrency. Furthermore, more NFTs the user converts into the loyalty scoring program of the sellers in said system, the level thereof gradually increases and the level of conversion into cryptocurrency progresses simultaneously.

The system of the invention enables sellers operating in different industries to easily carry their advertisements to the three-dimensional world and allows them to reach a right target audience at a minimum cost.

Said system provides an opportunity to find larger amounts of NFTs, tokens or rewards when the users thereof moves towards a location other than their location in the real or fictional world with a “Win by Moving/Exploring” strategy.

In addition, users find and collect NFTs in the real or fictional world and are allowed to physically use them in loyalty scoring or cryptocurrency or direct store systems (architectural areas, stores, playgrounds, etc.) of the sellers.

NFTs used in the system can be bought and sold as a detailed and high quality 3D object and/or text and/or picture and/or drawing and/or symbol.

### DESCRIPTION OF FIGURES

FIG. 1 is a view of a schematic block diagram of a system according to the invention.

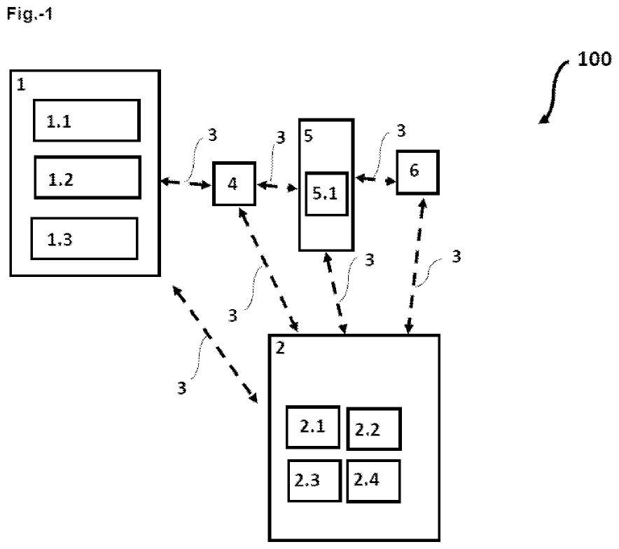

### DESCRIPTION OF THE REFERENCES IN THE FIGURES

In order to provide a better understanding of the invention, the numerals in the figures are provided below:
100. System
   1. Device
      1.1 Screen
      1.2 Interface
      1.3 Control Unit
   2. Server
      2.1 Database
      2.2 Storage Unit
      2.3 Audio Receiver Unit
      2.4 Audio Transmitter Unit
   3. Communication Unit
   4. Position Detecting Unit
   5. Image Detecting Unit
      5.1 Portal
   6. Safety Unit

### DETAILED DESCRIPTION OF THE INVENTION

The system (100) of the invention comprises at least one device (1); at least one server (2) to which the data is transmitted by said device (1) and in which the data is processed in an augmented or virtual reality environment by blockchain technology using artificial intelligence algorithms, wherein the server comprises information on users and/or sellers; and at least one communication unit (3) providing communication between the device (1) and the server (2).

The device (1) is at least one computer and/or at least one telephone. The device (1) includes at least one screen (1.1) through which at least one user displays the data; at least one interface (1.2) which enables a user to interact with the device (1); and a control unit (1.3) in which the transactions, such as data controlling, processing, etc., are performed.

The device (1) includes at least one web-based interface (1.2) which enables at least one user to control and monitor the entire process, enabling access to the system (100) from the real and/or fictional world.

The system (100) includes at least one database (2.1) containing all the data, at least one storage unit (2.2) in which the data in the database (2.1) is stored, and at least one position detecting unit (4) which provides tracking of the position/location/GPS information of the users.

In said system (100), a user may move to his/her location and/or any optional location by transferring the position/GPS information of the user in the position detecting unit (4) to the database (2.1).

The system (100) enables users to gain experience in the real and/or fictional world.

The system (100) includes at least one image detecting unit (5) which enables a user to view places designed in accordance with any date or period in the past and/or future times, especially in the real and/or fictional world. Users in the system (100) can enter the real and/or fictional world with at least one portal (5.1) located in the image detecting unit (5).

Users find and collect NFTs and/or tokens and/or rewards in the real or fictional world and are allowed to physically use them in loyalty scoring or cryptocurrency or direct store systems (architectural areas, stores, playgrounds, etc.) of the sellers.

NFTs used in the system can be bought and sold as a detailed and high quality 3D object and/or text and/or picture and/or drawing and/or symbol.

In the system (100) of the invention, there are NFT promo codes and/or discount codes, which are one of the loyalty programs of the companies, for the users. Said codes are embedded in at least one NFT by being encrypted in the real and/or fictional world. Thus, users are provided to sell and/or give a present within themselves via the blockchain. Said NFT promo or discount codes are symmetrically encrypted and only visible to the owner thereof. These codes are for single use only. They are burned through the system (100) after use. For example, the promo codes used cannot be reused later, and in this way users are not allowed to access this code again.

The system (100) includes at least one exchange and/or conversion unit. NFTs and/or tokens and/or rewards collected in said system (100) are converted into at least one cryptocurrency and/or scoring systems, one of the loyalty programs of the sellers, by the conversion unit. In addition, NFTs and/or tokens and/or rewards collected in said system (100) are transferred between users by the exchange unit.

The system (100) includes at least one random weighted token distribution algorithm. Due to said algorithm, an owner of the portal (5.1) is able to arrange random tokens and/or rewards for users entering the system (100) from the portal (5.1) at the predetermined rates and types. For example, the probability of showing the tokens and/or rewards desired to be found in the system (100) at 10 different rates on the portal (5.1) is calculated according to said algorithm. Said random weighted token distribution algorithm operates within at least one safety unit (6). Said algorithm provides a safe and accurately scalable rate as it is not made by the user and is made within the system (100).

Said distribution algorithm includes the following method steps:
In a first step, when at least one user logs in from the portal (5.1), initiating the distribution algorithm in at least one safety unit (6),
In a second step, distributing the tokens and/or rewards to the users on the portal (5.1),
In a third step, collecting said tokens and/or rewards by the user by the image detecting unit (5) and transferring them to the storage unit (2.2).

Options are shown to the user so that the user is able to create his/her digital identity and/or avatar in the storage unit (2.2) of the system (100). In said options, there is at least one color and/or at least one shape and/or at least one ready-made fictional exemplary avatar or identities on the server (2).

The system (100) of the invention operates according to the following method steps.
Logging into at least one portal (5.1) created by sellers by at least one user,
Collecting the NFTs determined by the sellers in the portal (5.1) and transferring the same to the database (2.1) of the system (100), by a user,
Transferring the NFTs collected by the user to the wallet in the blockchain network by at least one communication unit (3),
Using the NFTs earned for at least one product, optionally with promo codes preferably at rates determined by the sellers, and/or free, and/or with the reduced rates.

The method steps used in another preferred embodiment of the inventive system (100) are given below.
Logging into at least one portal (5.1) which is in the real and/or fictional world and/or determined by companies by at least one user,
Collecting the NFTs and/or tokens and/or rewards by the user on said portal (5.1) and transferring the same to the system (100) of the database (2.1),
Transferring the NFTs and/or tokens and/or rewards collected by the user to the wallet in the blockchain network by at least one communication unit (3),
Using the rewards won in the scoring system based on the loyalty program of the companies, and/or converting the earned tokens into cryptocurrency over the blockchain and/or transferring the NFTs won to the cryptocurrency exchange into cash.

The method steps used in another preferred embodiment for the operation of the inventive system (100) are given below.
Logging into at least one portal (5.1) determined in at least one real world by the user,
Selecting any predetermined (ready) or live place/location by the user on the system (100) from the database (2.1) by means of at least one position detecting unit (4),
If the user chooses the predetermined location, indicating the directions by the position detecting unit (4),
When the user arrives at the specified location, turning on the user's camera by activating the image detecting unit (5) and switching to an augmented reality scene,
Entering of the user by walking through the nearest portal (5.1),
Collecting NFTs and/or tokens and/or rewards displayed around the user with the augmented reality technology,
Transferring the collected NFTs and/or tokens and/or rewards to at least one wallet.

In the third step of the above-mentioned method steps, a position/location notification process via the position detecting unit (4) provides an audible and/or a silent guidance with the audio transmitter unit (2.4) in the system (100), but the application is not limited thereto.

The method steps used in another preferred embodiment for the operation of the inventive system (100) are given below.
Logging into at least one portal (5.1) determined in at least one fictional world by the user,
Displaying the portal selected by the user by retrieving from the database (2.1) of the interface (1.2) in the system (100) to the user on the device by means of the image detecting unit (4),
Entering of the user by walking through the nearest portal (5.1),
Exploring the portal (5.1) by the user by walking and/or moving the device (1) and/or watching and/or listening and/or playing at least one game, by means of the augmented reality technology,
Collecting the rewards in the portal (5.1) by the user.

In the fifth step of the above-mentioned method steps, the user is able to listen to the events and/or narrations set up in the system by the audio receiver unit (2.3) connected to the communication unit (3). In addition, the user is able to talk by a transfer to the database (2.1) of the system by means of the audio transmitter unit (2.4) connected to the communication unit (3).

In a preferred embodiment of the invention, the device (1) mentioned in the fifth step has a touch screen (1.1) as a telephone, which enables the screen (1.1) thereof to be moved easily.

In the fifth step of said method, the user is able to play the games in the system (100) within the portal (5.1). The user can also collect NFTs and/or tokens and/or rewards located in the portal (5.1). The user can purchase at least one land and/or at least one NFT over the system (100) with the collected NFT, tokens and rewards, and display the same to other users on the land purchased.

The system (100) allows both seller and users to create their own NFTs.

The method steps used for the sellers to create ads in the system (100) are provided below.
Logging into at least one portal (5.1) by at least one seller (trademark owners/advertisers),
Creating at least one NFT collection by the sellers on behalf of their companies,
Asking, by the interface (1.2) in the system (100), if they will continue as at least one discount and/or at least one gift coupon/code and/or at least one NFT,
If the sellers choose a discount or gift coupon/code, defining said discount codes as NFT,
Symmetric encrypting the discount or gift codes under the control of at least one safety unit (6),
if the sellers continue as NFTs, entering the NFTs as metadata for at least one NFT,
Adding the NFT collections created by the sellers to the loyalty scoring system and distributing them to the users over the system (100).

In the fifth step of said method, the symmetrically encrypted codes are burned after being used by the user and are for single use only. It is opened by another server (2) with the same key character string by encrypting the data related to a key character string that is kept securely during symmetric encryption (for example: promo code).

The Advantages Obtained with the Invention are Also Listed Below:
Despite an increase in the advertising costs and competition of the retail companies, the problems related to the system are minimized, and it is possible to make a target audience and place-oriented advertising strategy.
It eliminates the problem of individual users not being able to generate an income in any system or application, and makes a gain with at least one NFT and/or at least one token and/or at least one reward in the regions visited in the real and/or fictional world of the system (100). The NFTs, tokens and rewards earned are converted into real-world money from the virtual environment.
The system prevents the interruption of advertising methods via the traditional systems used in the present art in order to increase the trademark awareness of the sellers and ensures the same to be transmitted directly to an end user.
Due to the augmented reality technology of the invention, the in-system advertisements of the sellers are transferred to the three-dimensional world and are connected to the user's walking and movement in the real world.
The system (100) enables the user and/or the seller to create their own NFT markets and to buy and sell many types of NFT via said system.
The seller is able to show his/her advertisements to online or offline users over the system (100).

### Industrial Applicability of the Invention

The invention relates to a system (100) which allows transactions of a user, such as collecting, sharing and selling NFTs (non-fungible tokens) and/or tokens to be executed and the loyalty programs to be used more effectively, wherein the system converts NFTs (non-fungible tokens) and/or tokens transferred to a three-dimensional world by an augmented reality technology into loyalty scoring systems and/or cryptocurrencies of sellers operating in different industries, and is applicable to industry.

The invention is not limited to the above exemplary embodiments, and a person skilled in the art may easily present other different embodiments of the invention. These should be considered within the scope of protection of the invention claimed in the claims.

1. A system (100) which allows transactions such as collecting, sharing and selling NFTs (non-fungible tokens) and/or tokens to be executed and the loyalty programs to be used more effectively, in order to convert NFTs (non-fungible tokens) and/or tokens transferred to a three-dimensional world by an augmented reality technology into loyalty scoring systems and/or cryptocurrencies of sellers operating in different industries, comprising:
at least one device (1); at least one server (2) to which the data is transmitted by said device (1) and in which the data is processed in an augmented or virtual reality environment by blockchain technology using artificial intelligence algorithms, wherein the server comprises information on users and/or sellers; at least one communication unit (3) providing communication between the device (1) and the server (2); at least one screen (1.1) through which at least one user displays the data; characterized in that it comprises at least one web-based interface (1.2) which enables at least one user to control and monitor the entire process, enabling access to the system (100) from the real and/or fictional world; and a control unit (1.3) through which the transactions, such as data controlling, processing, etc., are performed; at least one database (2.1) comprising all data; at least one storage unit (2.2) in which the data in said database (2.1) is stored; and at least one position detecting unit (4) through which the position/location/GPS information of the users is tracked; at least one image detecting unit (5) which enables a user to view places designed in accordance with any date or period in the past and/or future times, especially in the real and/or fictional world; at least one portal (5.1) which allows users to enter the real and/or fictional world in the image detecting unit (5).

2. A method for operating the system (100) of the invention, comprising the steps of:
Logging into at least one portal (5.1) created by sellers by at least one user,
Collecting the NFTs determined by the sellers in the portal (5.1) and transferring the same to the database (2.1) of the system (100), by a user,
Transferring the NFTs collected by the user to the wallet in the blockchain network by at least one communication unit (3),
Using the NFTs earned for at least one product, optionally with promo codes preferably at rates determined by the sellers, and/or free, and/or with the reduced rates.

3. A method (100) of claim 2 for running at least one random weighted token distribution algorithm, comprising the steps of:
In a first step, when at least one user logs in from the portal (5.1), initiating the distribution algorithm in at least one safety unit (6),
In a second step, distributing the tokens and/or rewards to the users on the portal (5.1),
In a third step, collecting said tokens and/or rewards by the user via the image detecting unit (5) and transferring them to the storage unit (2.2).

4. The method as claimed in claim 3 for use in another preferred embodiment for operation of the system (100) according to the invention, comprising the steps of:
Logging into at least one portal (5.1) which is in the real and/or fictional world and/or determined by companies by at least one user,
Collecting the NFTs and/or tokens and/or rewards by the user on said portal (5.1) and transferring the same to the system (100) of the database (2.1),
Transferring the NFTs and/or tokens and/or rewards collected by the user to the wallet in the blockchain network by at least one communication unit (3),
Using the rewards won in the scoring system based on the loyalty program of the companies, and/or converting the earned tokens into cryptocurrency over the blockchain and/or transferring the NFTs won to the cryptocurrency exchange into cash.

5. The method as claimed in claim 4 for use in another preferred embodiment for operation of the system (100) according to the invention, characterized in that it comprises the following method steps of:
Logging into at least one portal (5.1) determined in at least one real 5 world by the user,
Selecting any predetermined (ready) or live place/location by the user on the system (100) from the database (2.1) by means of at least one position detecting unit (4),
If the user chooses the predetermined location, indicating the directions 10 by the position detecting unit (4),
When the user arrives at the specified location, turning on the user's camera by activating the image detecting unit (5) and switching to an augmented reality scene,
Entering of the user by walking through the nearest portal (5.1),
Collecting NFTs and/or tokens and/or rewards displayed around the user with the augmented reality technology,
Transferring the collected NFTs and/or tokens and/or rewards to at least one wallet.

6. The method as claimed in claim 5, wherein the position/location notification process via the position detecting unit (4) in the third step thereof provides an audible and/or a silent guidance with the audio transmitter unit (2.4) in the system (100).

7. The method as claimed in claim 6 for use in another preferred embodiment for operation of the system (100) according to the invention, comprising the steps of:
Logging into at least one portal (5.1) determined in at least one fictional world by the user,
Displaying the portal selected by the user by retrieving from the database (2.1) of the interface (1.2) in the system (100) to the user on the device by means of the image detecting unit (4),
Entering of the user by walking through the nearest portal (5.1),
Exploring the portal (5.1) by the user by walking and/or moving the device (1) and/or watching and/or listening and/or playing at least one game, by means of the augmented reality technology,
Collecting the rewards in the portal (5.1) by the user.

8. The method as claimed in claim 2 for the sellers to create an advertisement in the system (100), comprising the steps of:
Logging into at least one portal (5.1) by at least one seller (trademark owners/advertisers),
Creating at least one NFT collection by the sellers on behalf of their companies,
Asking, by the interface (1.2) in the system (100), if they will continue as at least one discount and/or at least one gift coupon/code and/or at least one NFT,
If the sellers choose a discount or gift coupon/code, defining said discount codes as NFT,
Symmetric encrypting the discount or gift codes under the control of at least one safety unit (6),
if the sellers continue as NFTs, entering the NFTs as metadata for at least one NFT,
Adding the created NFT collections by the sellers to the loyalty scoring system and distributing the same to the users over the system (100).
